(19) United States
(12) Patent Application Publication
(10) Pub. No.: US 2008/0209114 A1
(43) Pub. Date: Aug. 28, 2008

(54) Reliability High Endurance Non-Volatile Memory Device with Zone-Based Non-Volatile Memory File System

(75) Inventors: David Q. Chow, San Jose, CA (US); I-Kang Yu, Palo Alto, CA (US); Abraham Chih-Kang Ma, Fremont, CA (US); Ming-Shiang Shen, Hsin Chuang (TW)

Correspondence Address: ROGER H. CHU, 19499 ERIC DRIVE, SARATOGA, CA, 95070, US

(73) Assignee: Super Talent Electronics, Inc., San Jose, CA (US)

(21) Appl. No.: 12/101,877

(22) Filed: Apr. 11, 2008

Related U.S. Application Data
(63) Continuation-in-part of application No. 12/054,310, filed on Mar. 24, 2008.
Application No. 12/054,310 is a continuation-in-part of application No. 12/035,398, filed on Feb. 21, 2008.
Application No. 12/035,398 is a continuation-in-part of application No. 12/017,249, filed on Jan. 21, 2008.
Application No. 12/017,249 is a continuation-in-part of application No. 11/770,642, filed on Jun. 28, 2007.
Application No. 11/770,642 is a continuation-in-part of application No. 11/748,595, filed on May 15, 2007.
Application No. 11/748,595 is a continuation-in-part of application No. 10/818,653, filed on Apr. 5, 2004, now Pat. No. 7,243,185.
Application No. 10/818,653 is a continuation-in-part of application No. 12/025,706, filed on Feb. 4, 2008.
Application No. 12/025,706 is a continuation-in-part of application No. 11/871,011, filed on Oct. 11, 2007.
Application No. 11/871,011 is a continuation-in-part of application No. 11/926,743, filed on Oct. 29, 2007.
Application No. 11/926,743 is a continuation-in-part of application No. 11/624,667, filed on Jan. 18, 2007.
Application No. 11/624,667 is a division of application No. 09/478,720, filed on Jan. 6, 2000, now Pat. No. 7,257,714.
Application No. 09/478,720 is a continuation-in-part of application No. 09/366,976, filed on Aug. 4, 1999, now Pat. No. 6,547,130.

(51) Int. Cl. G06F 12/00

(52) U.S. Cl. 711/103; 711/E12.001

(57) ABSTRACT

Improved reliability high endurance non-volatile memory device with zone-based non-volatile memory file system is described. According to one aspect of the present invention, a zone-based non-volatile memory file system comprises a two-level address mapping scheme: a first level address mapping scheme maps linear or logic address received from a host computer system to a virtual zone address; and a second level address mapping scheme maps the virtual zone address to a physical zone address of a non-volatile memory module. The virtual zone address represents a number of zones each including a plurality of data sectors. Zone is configured as a unit smaller than data blocks and larger than data pages. Each of the data sector consists of 512-byte of data. The ratio between zone and the sectors is predefined by physical characteristics of the non-volatile memory module. A tracking table is used for correlating the virtual zone address with the physical zone address. Data programming and erasing are performed in a zone basis.

### CROSS-REFERENCE TO RELATED APPLICATIONS

This application is a continuation-in-part (CIP) of co-pending U.S. patent application for “High Integration of Intelligent Non-Volatile Memory Devices”, Ser. No. 12/054,310, filed Mar. 24, 2008, which is a CIP of “High Endurance Non-Volatile Memory Devices”, Ser. No. 12/035,398, filed Feb. 21, 2008.

This application is also a CIP of U.S. patent application for “High Performance Flash Memory Devices (FMD)”, U.S. application Ser. No. 12/017,249, filed Jan. 21, 2008, which is a CIP of “High Speed Controller for Phase Change Memory Peripheral Devices”, U.S. application Ser. No. 11/770,642, filed on Jun. 28, 2007, which is a CIP of “Local Bank Write Buffers for Acceleration a Phase Change Memory”, U.S. application Ser. No. 11/748,595, filed May 15, 2007, which is CIP of “Flash Memory System with a High Speed Flash Controller”, application Ser. No. 10/818,653, filed Apr. 5, 2004, now U.S. Pat. No. 7,243,185.

This application is also a CIP of co-pending U.S. patent application for “Method and Systems of Managing Memory Addresses in a Large Capacity Multi-Level Cell (MLC) based Flash Memory Device”, Ser. No. 12/025,706, filed on Feb. 4, 2008, which is a CIP application of “Flash Module with Plane-interleaved Sequential Writes to Restricted-Write Flash Chips”, Ser. No. 11/871,011, filed Oct. 11, 2007.

This application is also a CIP of co-pending U.S. patent application for “Hybrid SSD Using a Combination of SLC and MLC Flash Memory Arrays”, U.S. application Ser. No. 11/926,743, filed Oct. 29, 2007.

This application is also a continuation-in-part (CIP) of co-pending U.S. patent application Ser. No. 11/624,667 filed on Jan. 18, 2007, entitled “Electronic data Storage Medium with Fingerprint Verification Capability”, which is a divisional patent application of U.S. patent application Ser. No. 09/478,720 filed on Jan. 6, 2000, now U.S. Pat. No. 7,257,714 issued on Aug. 14, 2007, which has been petitioned to claim the benefit of CIP status of one of inventor's earlier U.S. patent application for “Integrated Circuit Card with Fingerprint Verification Capability”, Ser. No. 09/366,976, filed on Aug. 4, 1999, now issued as U.S. Pat. No. 6,547,130, all of which are incorporated herein as though set forth in full.

### FIELD OF THE INVENTION

The present invention relates to non-volatile memory devices, and more particularly to zone-based non-volatile memory file system.

### BACKGROUND OF THE INVENTION

Non-volatile memory (NVM) such as flash memory has become popular in the past decade. NVM is a specific type of electrically erasable programmable read-only memory (EEPROM) that is electrically erased and programmed (written) in large blocks of data. NVM has been used in memory cards and flash drives for storage and transfer of data between computers and other digital electronic products. More recently, NVM has been used as a storage device referred to as solid state drive (SSD) that may replace hard disk drive in a computer.

Flash memory stores information in an array of memory cells made from floating-gate transistors. Originally each cell in a flash memory device stores one bit of information either 0 or 1, hence, the device is referred to as single-level-cell (SLC) flash memory device. Some newer flash memory, known as multi-level cell (MLC) flash memory devices, can store more than one bit per cell by choosing between multiple levels of electrical charge being applied to the floating gates. It is advantageous that MLC devices can hold more information than SLC devices can. However, there are problems associated with the MLC devices, one of the problems is that the MLC devices has much lower reliability, for example, the MLC flash memory has an 10 times less endurance level than the SLC flash memory. In other words, data programming (writing) and data erasure to a MLC based flash memory device is limited.

In order to prolong the reliability, a MLC flash memory file system is used for managing the endurance. The MLC flash memory is organized in a number of data blocks and each data blocks is further partitioned into a number of data pages. In a MLC flash memory, data programming operations are only allowed to be performed in a block basis if only data block usage is tracked. In other words, if the data programming operation needs to write data to a particular data block that contains previous written data, a new data block will be required such that the previous data and the new data can be programming together. This data programming methodology results into faster wearing of the MLC flash memory due to frequent reprogramming or writing of data blocks. To overcome this problem, a data page usage may be tracked such that a sequential data page may be written into a same data block. Only out-of-sequence data programming of data pages within a data block would require a new data block. Although this solution may reduce certain unnecessary data programming to new data blocks, a new shortcoming is created. Because the number of data pages is much larger than that of the data blocks (e.g., 4096 or 8192 times larger), hardware (e.g., memory in MLC controller) requirement becomes much higher. This translates to higher costs or not even be feasible due to size requirement.

Given the foregoing drawbacks, problems and limitations of the prior art, it would be desirable to have an improved non-volatile memory file system.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Improved reliability high endurance non-volatile memory device with zone-based non-volatile memory file system is disclosed. According to one aspect of the present invention, a zone-based non-volatile memory file system comprises a two-level address mapping scheme: a first level address mapping scheme maps linear or logic address received from a host computer system to a virtual zone address; and a second level address mapping scheme maps the virtual zone address to a physical zone address of a non-volatile memory module. The virtual zone address represents a number of zones each including a plurality of data sectors.

Zone is configured as a unit smaller than data blocks and larger than data pages. As a result, a non-volatile memory module is divided into a plurality of data blocks, each block to zones, then data pages and finally data sectors. Each of the data sector consists of 512-byte of data. The ratio between zone and the sectors is predefined by physical characteristics of the non-volatile memory module. A tracking table is used for correlating the virtual zone address with the physical zone address.

According to another aspect, zone-based flash memory comprises hardware or logic shared by zones, for example, control interface logic of a zone-base non-volatile memory contain a set of word-lines and bit-lines for each zone.

According to yet another aspect, a data cache subsystem is used for prolonging the life cycle of a non-volatile memory device that includes both SLC and MLC flash memory. In a zone-based non-volatile memory file system, the data cache subsystem uses zone as a unit.

As the zone is configured to be smaller than the data block, the requirement of storing a zone is smaller than a data block. Since each zone must be erased or reprogrammed individually, it is more beneficial to use zones in the data cache subsystem.

According to an exemplary embodiment of the present invention, a zone-based non-volatile memory device (NVMD) includes at least the following: at least one non-volatile memory (NVM) module configured as a data storage of a host computer system as the NVMD is adapted to the host, wherein the at least one NVM module is partitioned into a plurality of data blocks, each of the data blocks is further divided into a plurality of zones, each of the zones comprises a plurality of data pages and each of the data pages includes at least one data sector; a NVM controller configured to manage one or more data read, data write and data erasure operations of the at least one NVM module, wherein the data write operation comprises writing data into any empty zone of the plurality of zones, while data erasure operation comprises erasing data of entire zone in a zone by zone basis; and an input/output (I/O) interface, coupling to the NVM controller, configured for receiving incoming data from the host and configured for sending outgoing data to the host.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-1D are block diagrams illustrating exemplary flash memory devices in accordance with various embodiments of the present invention;

FIG. 2A is a diagram showing an exemplary zone-based non-volatile memory device architecture in accordance with one embodiment of the present invention;

FIG. 2B is a diagram showing a two-level address mapping scheme of an exemplary zone-based non-volatile memory device, according to an embodiment of the present invention;

FIG. 3A is a diagram showing relationship between an exemplary cache subsystem and a logical sector address in accordance with one embodiment of the present invention;

FIG. 3B is a diagram depicting an exemplary zone address mapping relationship in accordance with one embodiment of the present invention;

FIG. 4 is a block diagram showing an exemplary control interface logic of a zone-based NVM module in accordance with one embodiment of the present invention;

FIGS. 5A-5H collectively is a flowchart illustrating an exemplary process of a data transfer operation in the NVMD of FIG. 1D, according to an embodiment of the present invention; and

FIGS. 6A-6H shows an exemplary sequence of data transfer operations based on the exemplary process 500 in the exemplar NVMD of FIG. 1D, according to an embodiment of the present invention.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

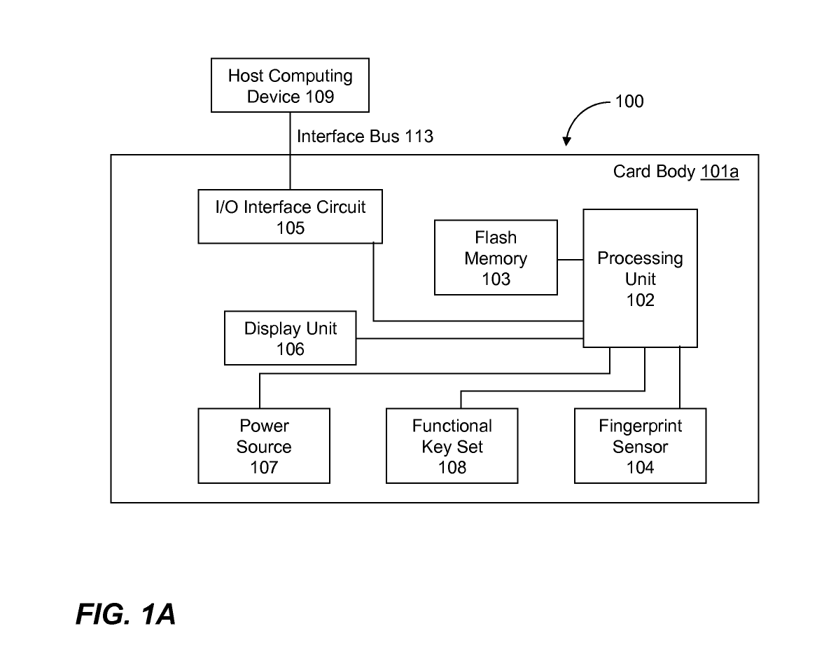

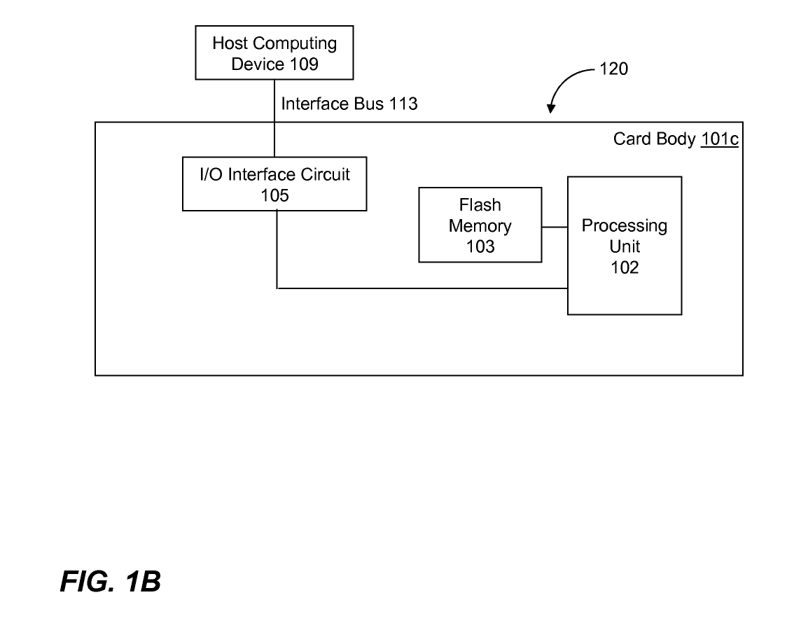

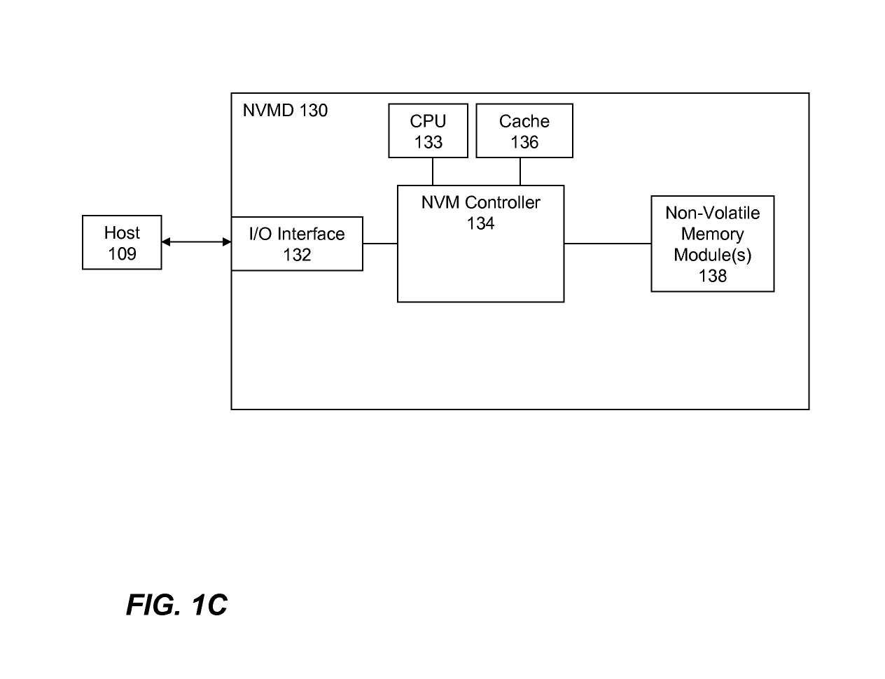

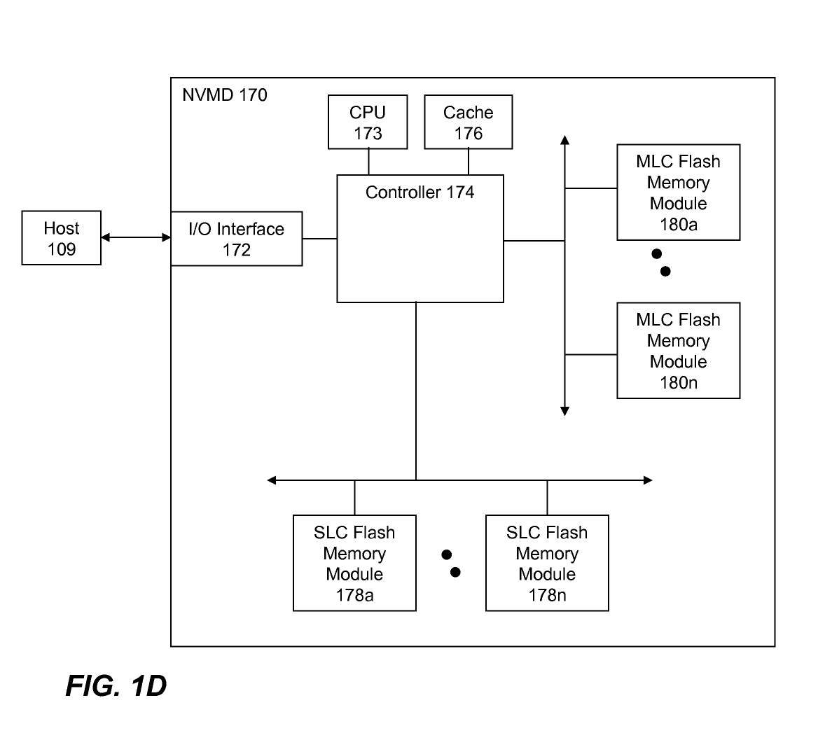

Embodiments of the present invention are discussed herein with reference to FIGS. 1A-6H. However, those skilled in the art will readily appreciate that the detailed description given herein with respect to these figures is for explanatory purposes as the invention extends beyond these limited embodiments.

FIGS. 1A-1D show functional diagrams of first, second, third and fourth zone-based non-volatile memory device (NVMD) in accordance with four embodiments of the present invention. FIG. 1A shows the first NVMD 100 adapted to be accessed by a host computing device 109 via an interface bus 113. The first NVMD 100 includes a card body 101a, a processing unit 102, at least one non-volatile memory (NVM) module 103, a fingerprint sensor 104, an input/output (I/O) interface circuit 105, an optional display unit 106, an optional power source (e.g., battery) 107, and an optional function key set 108. The host computing device 109 may include, but not be limited to, a desktop computer, a laptop computer, a mother board of a personal computer, a cellular phone, a digital camera, a digital camcorder, a personal multimedia player.

The card body 101a is configured for providing electrical and mechanical connection for the processing unit 102, the NVM module 103, the I/O interface circuit 105, and all of the optional components. The card body 101a may comprise a printed circuit board (PCB) or an equivalent substrate such that all of the components as integrated circuits may be mounted thereon. The substrate may be manufactured using surface mount technology (SMT) or chip on board (COB) technology.

The processing unit 102 and the I/O interface circuit 105 are collectively configured to provide various control functions (e.g., data read, write and erase transactions) of the NVM module 103. The processing unit 102 may also be a standalone microprocessor or microcontroller, for example, an 8051, 8052 or 80286 Intel® microprocessor, or ARM®, MIPS® or other equivalent digital signal processors. The processing unit 102 and the I/O interface circuit 105 may be made in a single integrated circuit, for application specific integrated circuit (ASIC).

The at least one NVM module 103 may comprise one or more NVM chips or integrated circuits. The flash memory chips may be single-level cell (SLC) or multi-level cell (MLC) based. In SLC flash memory, each cell holds one bit of information, while more than one bit (e.g., 2, 4 or more bits) are stored in a MLC flash memory cell.

The fingerprint sensor 104 is mounted on the card body 101a, and is adapted to scan a fingerprint of a user of the first electronic NVM device 100 to generate fingerprint scan data. Details of the fingerprint sensor 104 are shown and described in a co-inventor's U.S. Pat. No. 7,257,714, entitled “Electronic Data Storage Medium with Fingerprint Verification Capability” issued on Aug. 14, 2007, the entire content of which is incorporated herein by reference.

The NVM module 103 stores, in a known manner therein, one or more data files, a reference password, and the fingerprint reference data obtained by scanning a fingerprint of one or more authorized users of the first NVM device. Only authorized users can access the stored data files. The data file can be a picture file, a text file or any other file. Since the electronic data storage compares fingerprint scan data obtained by scanning a fingerprint of a user of the device with the fingerprint reference data in the memory device to verify if the user is the assigned user, the electronic data storage can only be used by the assigned user so as to reduce the risks involved when the electronic data storage is stolen or misplaced.

The input/output interface circuit 105 is mounted on the card body 101a, and can be activated so as to establish communication with the host computing device 109 by way of an appropriate socket via an interface bus 113. The input/output interface circuit 105 may include circuits and control logic associated with a Universal Serial Bus (USB) interface structure that is connectable to an associated socket connected to or mounted on the host computing device 109. The input/output interface circuit 105 may also be other interfaces including, but not limited to, Secure Digital (SD) interface circuit, Micro SD interface circuit, Multi-Media Card (MMC) interface circuit, Compact Flash (CF) interface circuit, Memory Stick (MS) interface circuit, PCI-Express interface circuit, a Integrated Drive Electronics (IDE) interface circuit, Serial Advanced Technology Attachment (SATA) interface circuit, external SATA, Radio Frequency Identification (RFID) interface circuit, fiber channel interface circuit, optical connection interface circuit.

The processing unit 102 is controlled by a software program module (e.g., a firmware (FW)), which may be stored partially in a ROM (not shown) such that processing unit 102 is operable selectively in: (1) a data programming or write mode, where the processing unit 102 activates the input/output interface circuit 105 to receive data from the host computing device 109 and/or the fingerprint reference data from fingerprint sensor 104 under the control of the host computing device 109, and store the data and/or the fingerprint reference data in the NVM module 103; (2) a data retrieving or read mode, where the processing unit 102 activates the input/output interface circuit 105 to transmit data stored in the NVM module 103 to the host computing device 109; or (3) a data resetting or erasing mode, where data in stale data blocks are erased or reset from the NVM module 103. In operation, host computing device 109 sends write and read data transfer requests to the first NVM device 100 via the interface bus 113, then the input/output interface circuit 105 to the processing unit 102, which in turn utilizes a NVM controller (not shown or embedded in the processing unit) to read from or write to the associated at least one NVM module 103. In one embodiment, for further security protection, the processing unit 102 automatically initiates an operation of the data resetting mode upon detecting a predefined time period has elapsed since the last authorized access of the data stored in the NVM module 103.

The optional power source 107 is mounted on the card body 101a, and is connected to the processing unit 102 and other associated units on card body 101a for supplying electrical power (to all card functions) thereto. The optional function key set 108, which is also mounted on the card body 101a, is connected to the processing unit 102, and is operable so as to initiate operation of processing unit 102 in a selected one of the programming, data retrieving and data resetting modes. The function key set 108 may be operable to provide an input password to the processing unit 102. The processing unit 102 compares the input password with the reference password stored in the NVM module 103, and initiates authorized operation of the first NVM device 100 upon verifying that the input password corresponds with the reference password. The optional display unit 106 is mounted on the card body 101a, and is connected to and controlled by the processing unit 102 for displaying data exchanged with the host computing device 109.

Shown in FIG. 1B, the second zone-based NVM device 120 includes a card body 101c with a processing unit 102, an I/O interface circuit 105 and at least one NVM module 103 mounted thereon. Similar to the first NVM device, the second NVM device 120 couples to a host computing device 109 via an interface bus 113. Fingerprint functions such as scanning and verification are handled by the host computing device 109.

Referring now to the drawings, FIG. 1C is a functional block diagram showing salient components of a third exemplary zone-based NVMD 130 may be deployed as a data storage for the host computer system 109 in accordance with one embodiment of the present invention. The NVMD 130 comprises at least one microprocessor or central processing unit (CPU) 133, an input/output (I/O) controller 132, a non-volatile memory (NVM) controller 134, a data cache subsystem 136 and at least one non-volatile memory module 138.

When the NVMD 130 is adapted to the host computer system 109, the I/O interface 132 is operable to ensure that data transfer between the host 109 and the at least one non-volatile memory module 138 through one of the industry standards including, but not limited to, Advanced Technology Attachment (ATA) or Parallel ATA (PATA), Serial ATA (SATA), Small Computer System Interface (SCSI), Universal Serial Bus (USB), Peripheral Component Interconnect (PCI) Express, ExpressCard, fiber channel Interface, optical connection interface circuit, Secure Digital. The CPU 133 comprises a general purpose processing unit (e.g., a standalone chip or a processor core embedded in a system on computer (SoC)) configured for executing instructions loaded on the main storage (e.g., main memory (not shown)). The NVM controller 134 is configured to manage data transfer operations between the host computer system 100 and the at least one non-volatile memory module 138. Types of the data transfer operations include data reading, writing (also known as programming) and erasing. The data transfer operations are initiated by the host 109. Each of the data transfer operations is accomplished with a logical address (e.g., logical sector address (LSA)) from the host 109 without any knowledge of the physical characteristics of the NVMD 130.

The data cache subsystem 136 comprises of volatile memory such as random access memory (e.g., dynamic random access memory (DRAM)) coupled to the CPU 133 and the NVM controller 134. The cache subsystem 136 is configured to hold or cache either incoming or outgoing data in data transfer operations to reduce number of data writing/programming operations directly to the at least one non-volatile memory module 138. The cache subsystem 136 includes one or more levels of cache (e.g., level one (L1) cache, level two (L2) cache, level three (L3) cache, etc.). The cache subsystem 136 may use one of the mapping schemes including direct mapping, fully associative and N-set (N-way) associative. N is a positive integer greater than one. According to one aspect, the cache subsystem 136 is configured to cover the entire range of logical address, which is mapped to physical address of the at least one non-volatile memory module 138.

Each of the at least one non-volatile memory module 138 may include at least one non-volatile memory chip (i.e., integrated circuit). Each chip includes one or more planes of flash cells or arrays. Each plane comprises an independent page register configured to accommodate parallel data transfer operations. Each plane of the non-volatile memory chip is arranged in a data structure as follows: Each of the chips is divided into a plurality of data blocks and each block is then partitioned into a plurality of data pages. Each of the pages may contain one or more addressable data sectors in a data area and other information such as error correcting code (ECC) in a spare area. The data erasing in the non-volatile memory is perform in a data block by data block basis, while the data reading and writing can be performed for each data sector. The data register is generally configured to hold one data page including both data and spare areas. The non-volatile memory may include, but not be limited to, SLC flash memory (SLC), MLC flash memory (MLC), phase-change memory, Magnetoresistive random access memory, Ferroelectric random access memory, Nano random access memory.

A fourth exemplary zone-based NVMD 170 is shown in FIG. 1D, according to another embodiment of the present invention. Most of the components of the fourth NVMD 170 are the same as those of the third NVMD 130 except the fourth NVMD 170 includes two types of flash memory modules: SLC 178a-n and MLC 180a-n. The SLC and MLC flash memory modules are configured in a hierarchical scheme with the SLC 178a-n placed between the cache subsystem 176 and the MLC 180a-n, while the SLC and MLC flash memory modules are collectively provided as a data storage device to the host computer 109. A copy of the data cached in the cache subsystem 176 is stored in the SLC 178a-n such that the most-recently used data are accessed without accessing the MLC 180a-n, hence reducing the number of data writing or programming directly into the MLC 180a-n.

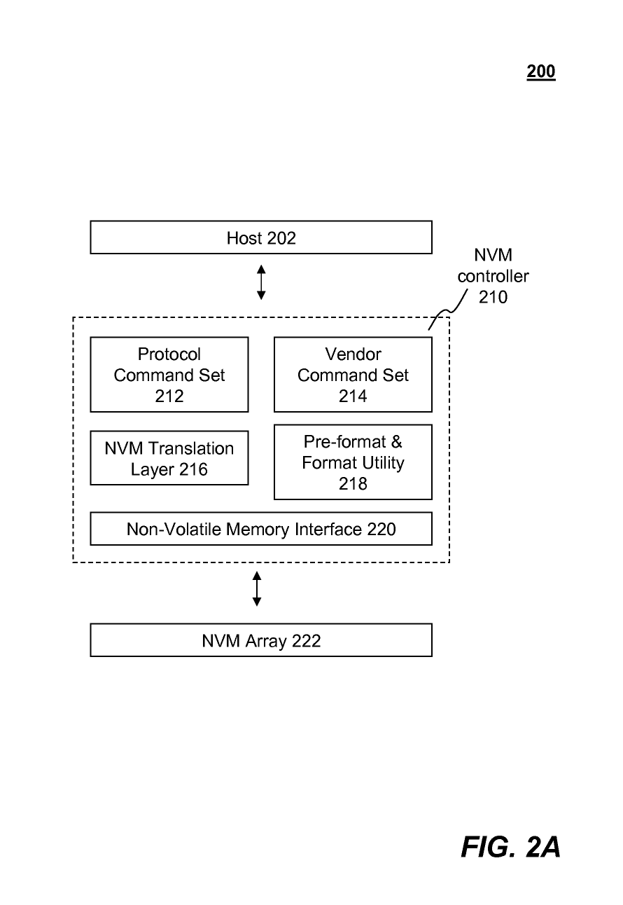

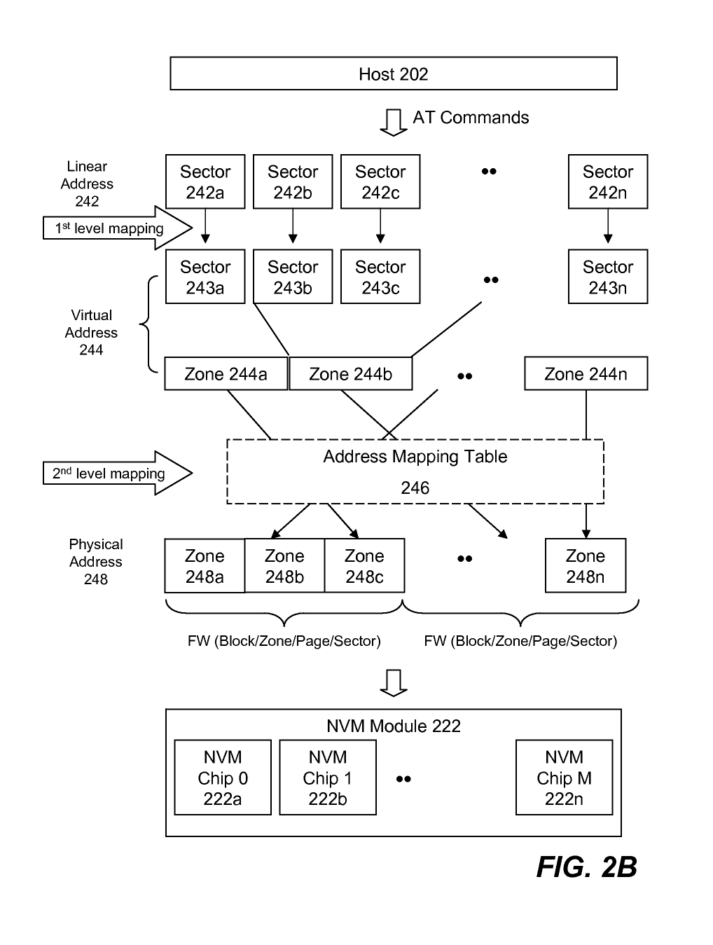

FIG. 2A shows an exemplary architecture 200 of a zone-based NVMD in accordance with one embodiment of the present invention. The architecture 200 includes a host computer system 202, a NVM controller 210 and NVM array 222. The NVM controller 210 is configured to be controlled by firmware for three major functions: 1) command interface, 2) NVM block and/or zone management and 3) NVM interface. The command interface comprises a protocol command set 212 (e.g., USB, SD/MMC, SATA, etc.) and a vendor command set 214 (e.g., Samsung, Toshiba, etc.). The NVM zone management includes NVM translation layer 216 and a pre-format and format utility 218. The NVM translation layer 216 is configured to create virtual zone address of a linear address issued by the host 202 and make the NVM appeared to be a hard disk drive to an operation system of the host 202. For example, cylinders, tracks, sectors are emulated such that the AT commands (i.e., Hayes commands for data communication) can work properly. The pre-format and format utility 218 is configured to format the NVM module such that the NVM would appear to be a hard disk. The NVM interface 220 is configured to retrieve data from the NVM array 222 and to write data to the NVM array 222.

FIG. 2B shows a diagram showing a two-level address mapping scheme of an exemplary zone-based non-volatile memory device, according to an embodiment of the present invention. A host computer system 202 issues AT commands with a linear address 242 (e.g., logical sector address (LSA)), which may include sector address 242a-n. The linear address 242 is mapped to a virtual zone address 244 in the first level of the two-level mapping scheme by firmware (FW) of a NVM controller. The virtual address 244 may contain a plurality of zone address 244a-n. Each of the zones is a group of sectors 243a-n.

The virtual address 244 or virtual zone address 244a-n is then mapped to a physical address 248 or physical zone address 248a-n via a second level address mapping scheme. The second level mapping is configured to be tracked in an address mapping table 246, in which a one-to-one relationship is correlated to ensure each virtual address 244 corresponds to a physical location in the NVM module 222. Firmware also groups block, zone, page and sector in a unit. The NVM module 222 may include at least one NVM chip (i.e., ‘NVM Chip 0’ 222a, ‘NVM Chip 1’ 222b, . . . ‘NVM Chip M’, 222n).

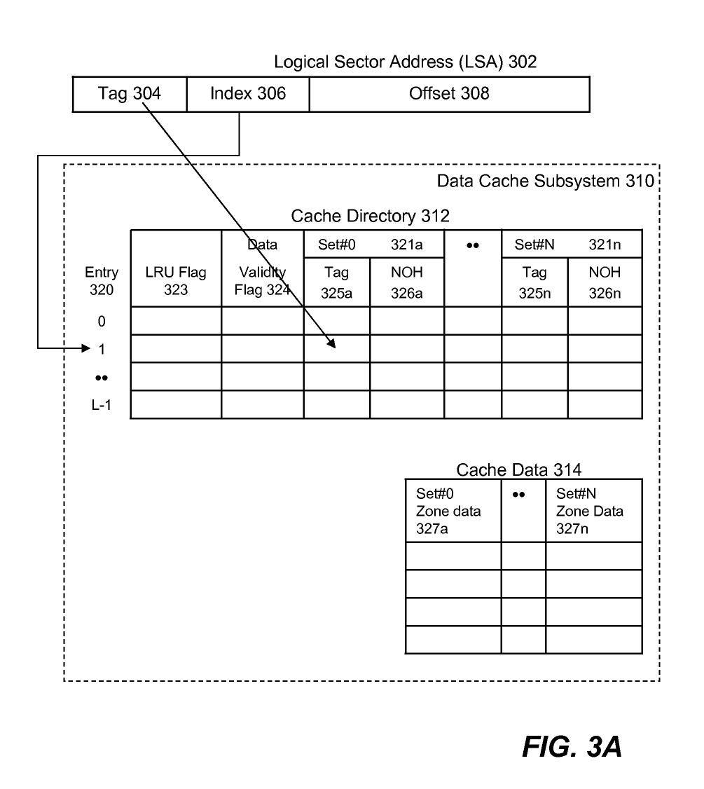

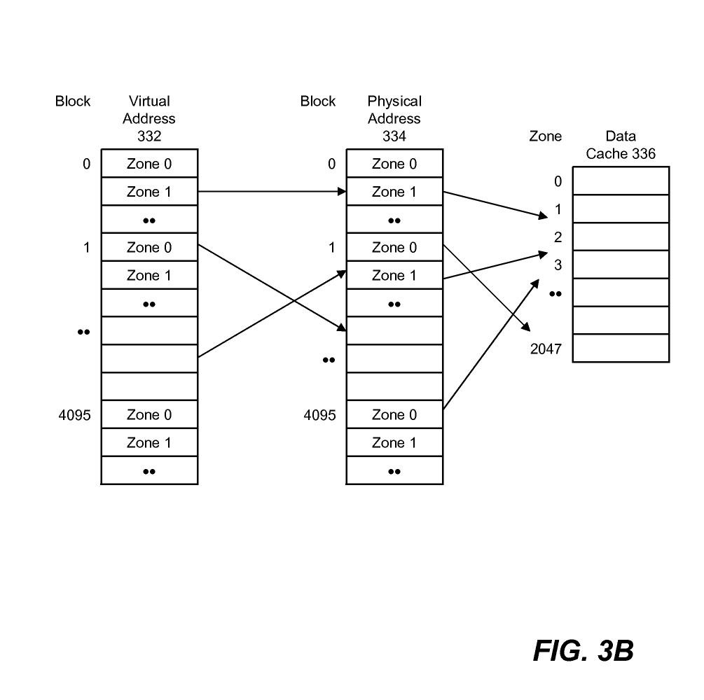

FIG. 3A shows the relationship between a logical section address (LSA) 302 and an exemplary data cache subsystem 310 in accordance with one embodiment of the present invention. LSA is partitioned into a tag 304, an index 306 and an offset 308. The data cache subsystem 310 comprises cache directory 312 and cache data 314. The cache subsystem 310 is configured using an N-set associative mapping scheme. N is a positive integer greater than one. The cache directory 312 comprises a plurality of cache entries 320 (e.g., L entries shown as 0 to (L−1)). Each of the cache entries 320 comprises N sets or ways (e.g., ‘set#0’ 321a . . . ‘set#N’ 321n) of cache line. Each set 321a-n of the cache lines comprises a tag field 325a-n, a number-of-write-hits (NOH) field 326a-n, and data field 327a-n. In addition, a least-recently used (LRU) flag 323 and a data validity flag 324 are also included for each entry in the cache directory 312. The LRU flag 323 is configured as an indicator to identify which one of the N sets of cache line is least-recently used. The data validity flag 324 is configured to indicate whether the cache data 314 is valid (i.e., identical content with the stored data in the non-volatile memory module).

The relationship between the LSA 302 and the cache subsystem 310 is as follows: First, the index 306 of the LSA 302 is used for determining which entry of the cache directory 312 (e.g., using the index 306 as the entry number of the cache directory 312). Next, based on the data validity flag 324 and the LRU flag 323, one of the N sets 327a-n of the cache line is selected to store the data associated with the LSA 302. Finally, the tag 304 of the LSA 302 is filled into the respective one of the tag field 325a-n corresponding to the selected set of the N sets 327a-n of the cache line. The offset 308 may be further partitioned into block, zone, page and sector offsets that match the data structure of the non-volatile memory in the zone-base NVMD 170. For example, the cache data 314 comprises N sets of zone data.

FIG. 3B shows another diagram depicting an exemplary zone address mapping relationship in accordance with one embodiment of the present invention. Virtual address 332 of a zone-based NVMD 170 of FIG. 1D comprises a plurality of data blocks (4096 shown) with each block divided into a plurality of zones (i.e., ‘zone 0’, ‘zone 1’, . . . ). The virtual address 332 is then mapped to a physical address 334 with a one-to-one relationship. An address mapping table 216 of FIG. 2B is used for correlating this mapping relationship. Finally the contents of the most recently accessed zones are stored in a data cache 336. For illustrating simplicity, a direct mapping cache is shown in FIG. 3B.

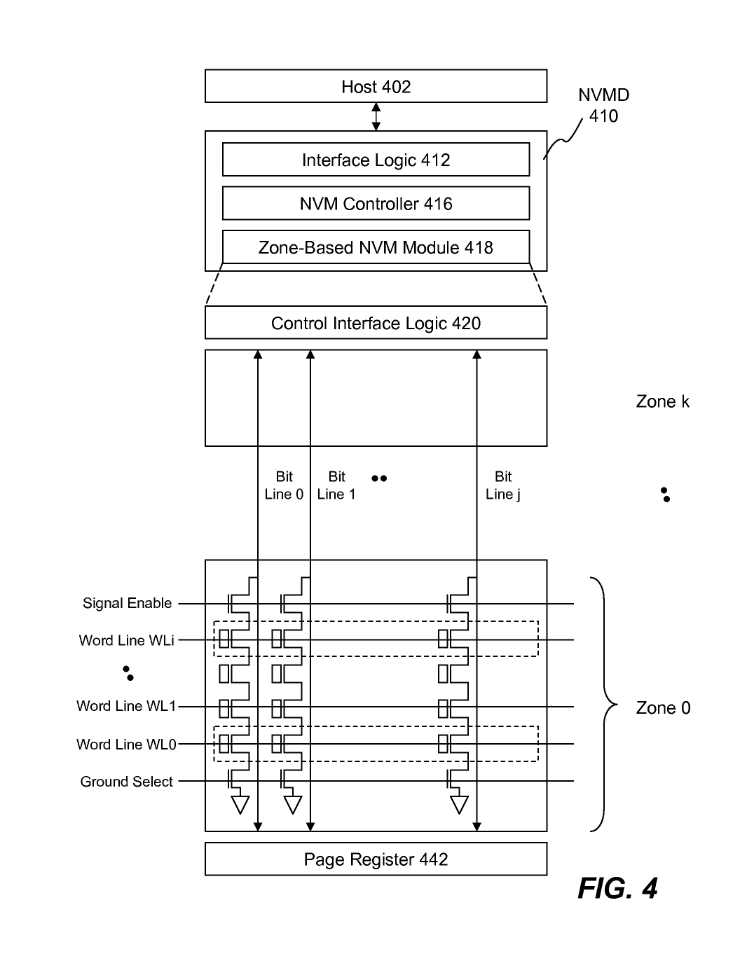

FIG. 4 is a diagram showing an exemplary control interface logic of a zone-based NVM module in accordance with one embodiment of the present invention. A NVMD 410 is configured to be a storage device as the NVMD 410 is adapted to a host computer system 402. The NVMD 410 comprises an interface logic 412, a controller 416 and at least one zone-based NVM module 418 that includes a control interface logic 420. Because the NVM module 418 is zone based, the control interface logic 420 includes separate hardware or integrated circuit for each of the zones (e.g., ‘zone 0’, ‘zone 1’, . . . ‘zone k’). Each separate hardware includes ‘ground select’, word-lines (i.e., ‘WL0’, ‘WL1’, . . . ‘WLi’) and ‘signal enable’ circuits. There are a plurality of bit-lines (i.e., ‘bit-line 0’, ‘bit-line 1’, . . . ‘bit-line j’) orthogonal to each of the word-lines. A page register 442 is shared by all of the zones within individual independent plane of a NVM chip. For example, 16 word-lines with 256 bit-lines can form a 512-byte data input/output circuitry.

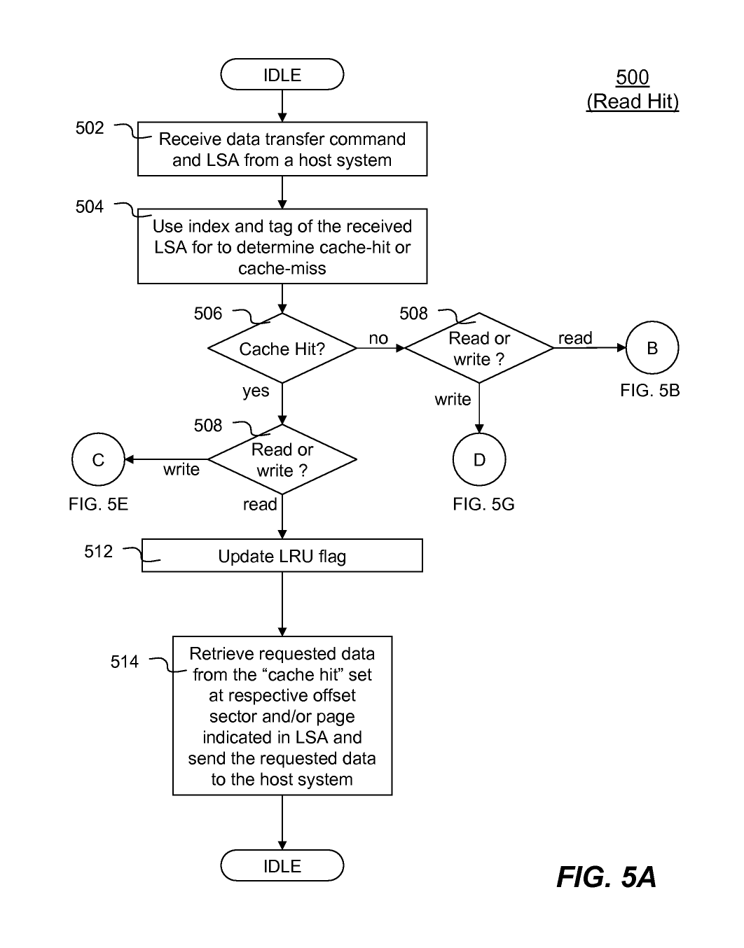

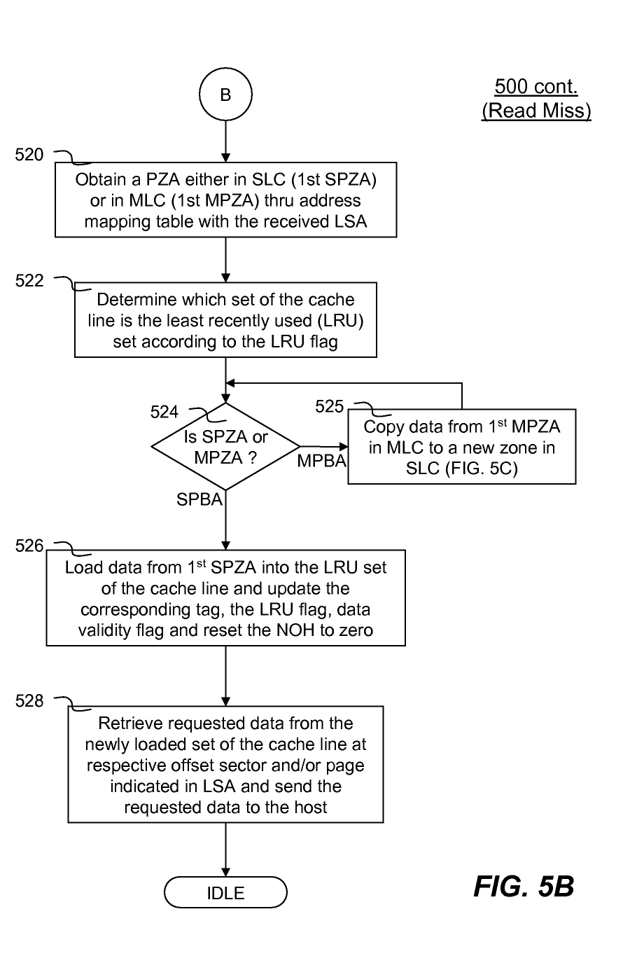

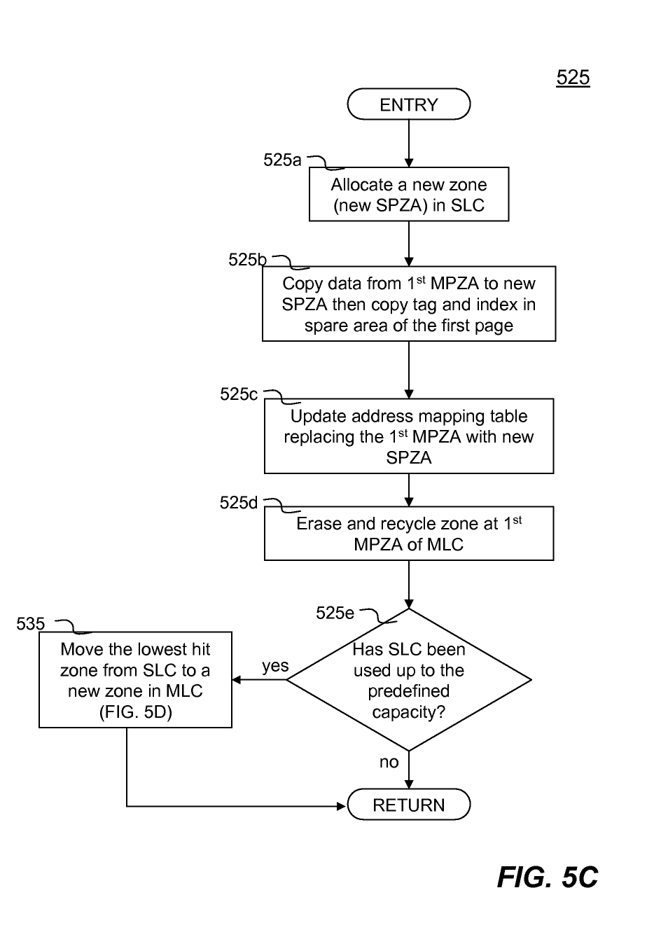

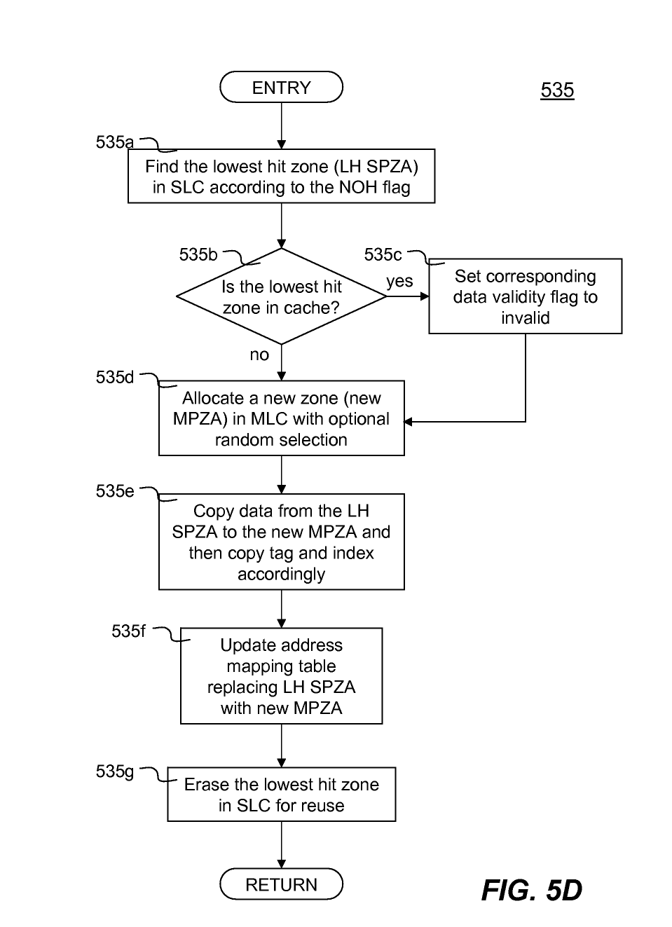

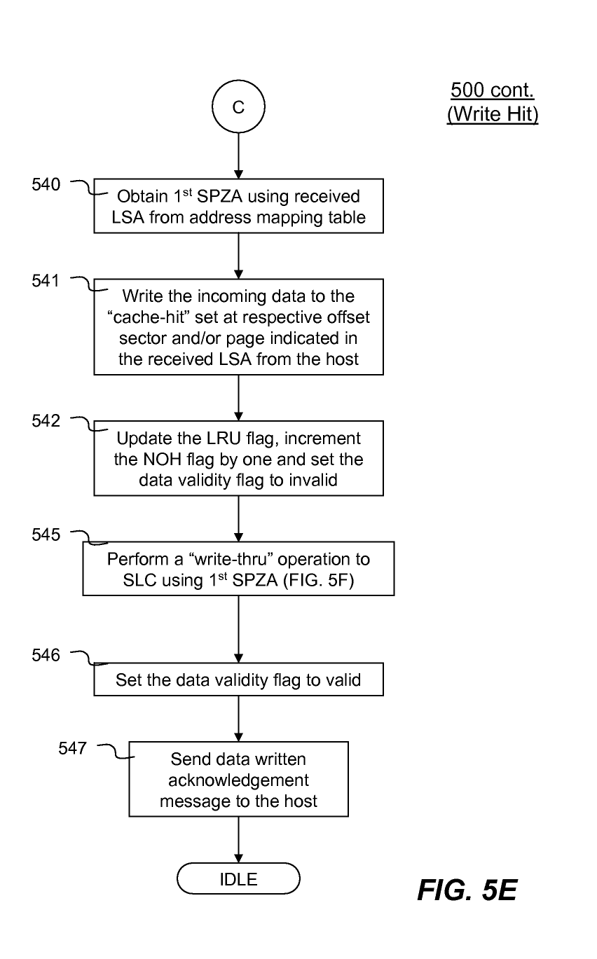

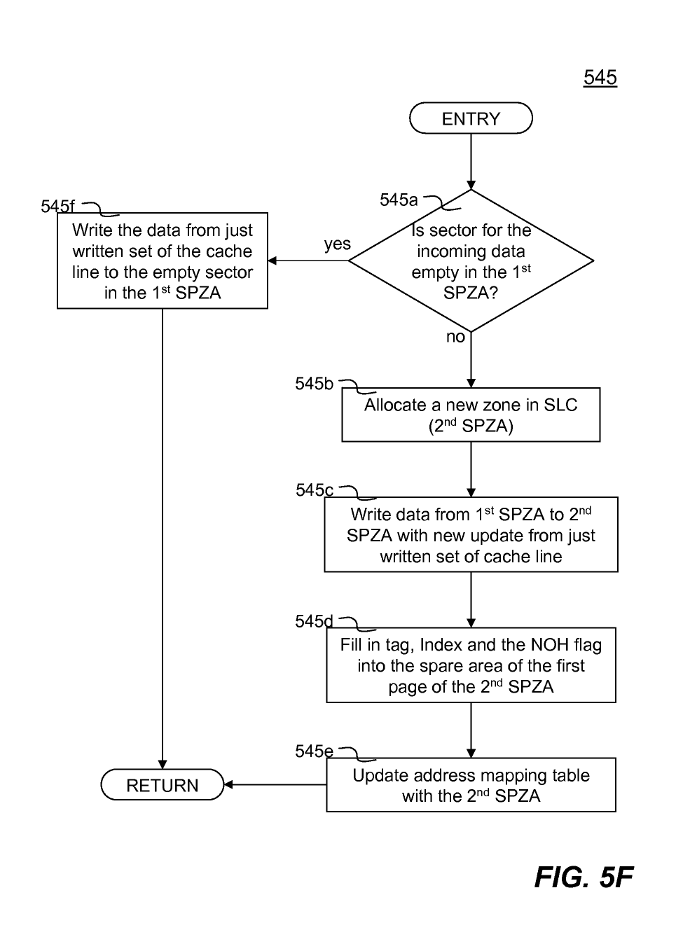

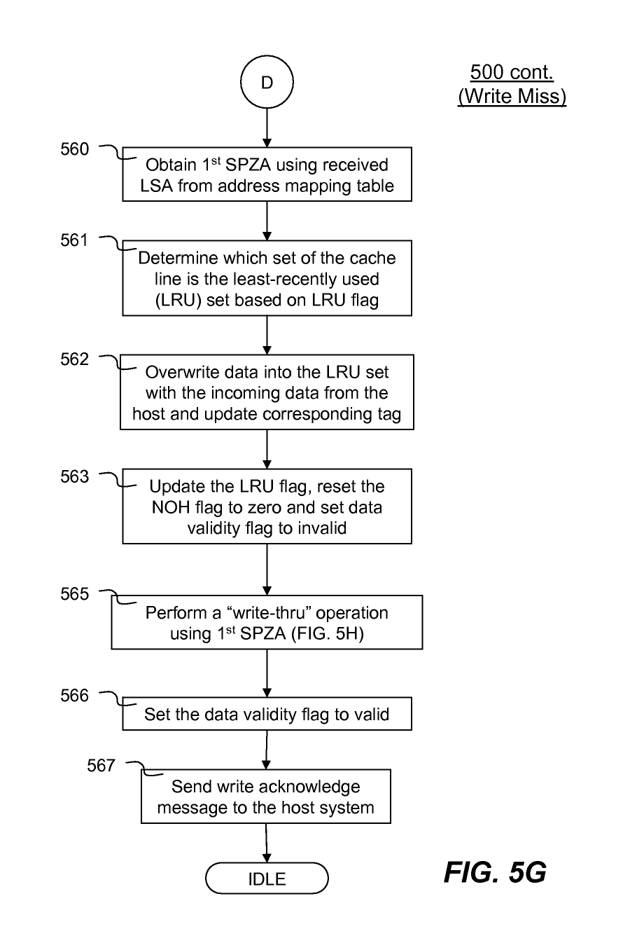

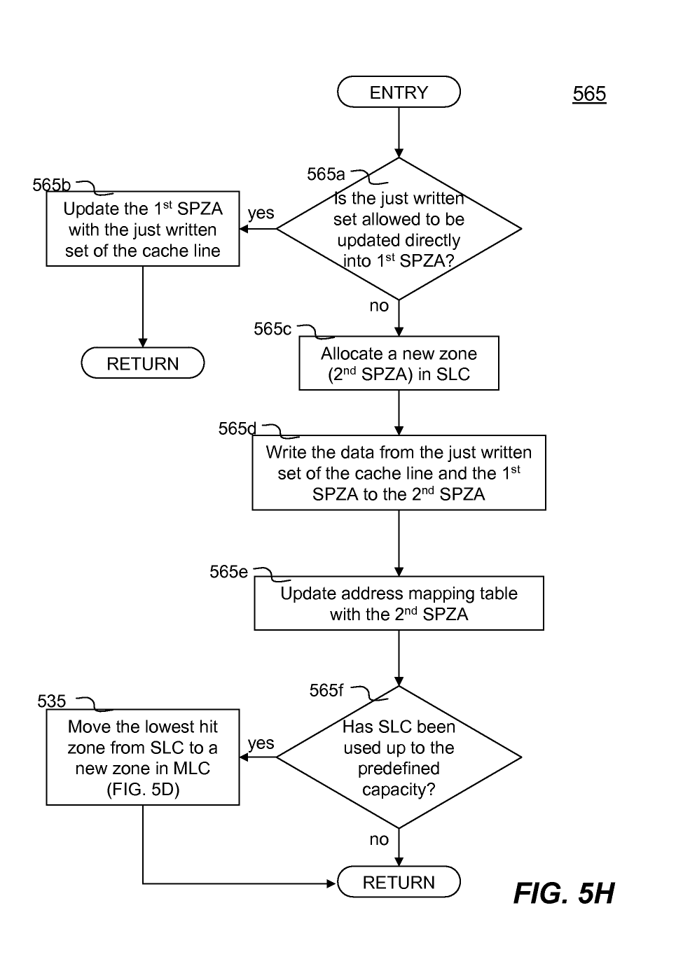

FIGS. 5A-5H collectively is a flowchart illustrating an exemplary process 500 of a data transfer operation in the zone-based NVMD 170 of FIG. 1D, according to an embodiment of the present invention. The process 500 is preferably understood with previous figures especially FIGS. 3A-3B.

The process 500 starts with an ‘IDLE’ state until the NVMD 170 receives a data transfer request from a host computer system (e.g., the host 109) at 502. Along with the data transfer request is a logical sector address (LSA) 302 and type of the data transfer request (i.e., data read or write). Next, at 504, process 500 extracts a tag 304 and an index 306 from the received LSA 302. The received index 306 corresponds to the entry number of the cache directory while the received tag 304 is used for comparing with all of the tags 325a-n in that cache entry. The process 500 moves to decision 506 to determine whether there is a ‘cache-hit’ or a ‘cache-miss’. If any one of the tags in the N sets of cache entries matches the received tag 304, a ‘cache-hit’ condition is determined, which means data associated with the received LSA 302 in the data transfer request is already stored in the cache subsystem 310. Otherwise, if none of the tags 325a-n matches the received tag, a ‘cache-miss’ condition is determined, which means that the data associated with the received LSA 302 is not currently stored in the cache subsystem 310. The data transfer operation for these two conditions is very different in the zone-based NVMD 170.

After decision 506, the process 500 checks the data transfer request type at decision 508 to determine whether a data read or write operation is requested. If ‘cache-miss’ and ‘data read’, the process 500 continues to the steps and decisions in FIG. 5B. If ‘cache-miss’ and ‘data write’, the process 500 goes to the steps and decisions in FIG. 5G. If ‘cache-hit’ and ‘data write’, the process 500 moves to the steps and decisions in FIG. 5E.

Otherwise in a ‘cache-hit’ and ‘data read’ condition, the process 500 updates the least-recently used (LRU) flag 323 at 512. Next, at 514, the process 500 retrieves the requested data from the ‘cache-hit’ set of the N sets of the cache line with the offset 308, which is an offset for a particular zone, page and/or sector in the received LSA 302 and then sends the retrieved data back to the host 109 of FIG. 1D. The process 500 goes back to the ‘IDLE’ state for waiting for another data transfer request.

For the case of ‘cache-miss’ and ‘data read’ shown in FIG. 5B, the process 500 obtains a physical zone address either in the SLC (e.g., SLC 178a-n of FIG. 1D) or in the MLC (e.g., 180a-n of FIG. 1D) that maps to a virtual zone address (LZA) through an address mapping table 246 at 520. Next, the least-recently used set is determined according to the LRU flag stored in the cache directory at 522. Then at decision 524, it is determine whether the physical zone address of the requested data is located in the SLC (SPZA) or the MLC (MPZA). If the requested data is in the MLC, the process 500 moves to 525, in which the requested data is copied from the MLC at the MPZA to a new zone in the SLC such that the requested data is found in the SLC. Details of step 525 are described in FIG. 5C.

If at decision 524, it is determines the requested data is stored in the SLC, the request data is loaded from the SLC at the SPZA into the least-recently used set of the cache line at 526. The process 500 also updates the tag 325a-n, the LRU flag 323 and data validity flag 324, and then resets the NOH flag 326a-n to zero, accordingly. Next, at 528, the requested data is retrieved from the just loaded cache line and sent back to the host 109. The process 500 goes back to the ‘IDLE’ state.

Shown in FIG. 5C is the detail process of step 525. The process 500 allocates a new zone (at new SPZA) in the SLC at 525a. Next, at 525b, the process 500 copies the data from the physical zone address (i.e., old MPZA) in the MLC associated with the received LSA to the new SPZA. Then the process 500 updates the address mapping table with the new SPZA replacing the old MPZA at 525c. At 525d, the zone in MLC at the old MPZA is erased for reuse (i.e., recycling). Then at decision 525e, it is determined whether the SLC has been used up to its predefined capacity. If ‘no’, the process 500 returns. Otherwise, the process 500 moves the lowest hit zone in the SLC to a new zone in the MLC at 535 before returning.

The detailed process of step 535 is shown in FIG. 5D, in which the process 500 first finds the lowest hit zone in the SLC (i.e., the zone has been least written). To determine the lowest hit zone, it may be done by searching through the NOH flag stored in the spare area of the first page of each of the zones in the SLC at 535a. Next, at decision 535b, it is determined whether the lowest hit zone is loaded in the data cache subsystem. If ‘yes’, the data validity flag for that cache line is set to invalid at 535c. Otherwise, the process 500 moves directly to 535d by allocating a new zone in the MLC. The allocation may be conducted in a number of schemes including, but not limited to, sequentially, randomly. For the random allocation, a probability density function or a cumulative distribution function is used in conjunction with a pseudo random number generator for the selection. Next, at 535e, the process 500 copies the data from the lowest hit zone in the SLC to the newly allocated zone in the MLC and copy tag and index to the spare area of the first page accordingly. At 535f, the address mapping table is updated to reflect the new zone of the MLC corresponds to the logical address now instead of the lowest hit zone in the SLC. Finally, the lowest hit zone in the SLC is erased and available for reuse at 535g.

Referring back to the condition of ‘cache-hit’ and ‘data write’, the process 500 continues in FIG. 5E. At 540, the process 500 obtains a physical zone address based on the received LSA through the address mapping table. Then, at 541, the incoming data is written to the ‘cache-hit’ set of the cache line. At 542, the process 500 updates the LRU flag, increments the NOH flag by one and sets the data validity flag to invalid. Then, at 545, the process 500 performs a ‘write-thru’ operation to the SLC using the physical zone address obtained in step 540. The details of the step 545 are described in FIG. 5F. After the ‘write-thru’ operation, the data validity flag is set back to valid at 546. Finally at 547, a data written acknowledgement message or signal is sent back to the host 109 before the process 500 goes back to the ‘IDLE’ state.

FIG. 5F shows the details of step 545. First at decision 545a, it is determined whether the incoming data is allowed to be directly written in the physical zone of the SLC at the obtained physical zone address (i.e., 1^{st} SPZA). For example, an empty sector in the SLC is allowed to be directly written into. If ‘yes’, data in the ‘cache-hit’ set of the cache line is written into the respective location (i.e., sector) in the SLC at the 1^{st} SPZA at 545f before returning. Otherwise, the process 500 allocates a new zone (i.e., 2^{nd} SPZA) in the SLC at 545b. Next, the data is copied from the 1^{st} SPZA to the 2^{nd} SPZA with the update from the data in the ‘cache-hit’ set of the cache line at 545c. Then at 545d, the process 500 copies the tag, index, set number and NOH flag to the spare area of the first page of the 2^{nd} SPZA accordingly. Finally, at 545g, the address mapping table is updated with the 2^{nd} SPZA before the process 500 returns.

FIG. 5G shows the detailed process for the condition of ‘cache-miss’ and ‘data write’. First at 560, the process 500 obtains a 1^{st} SPZA based on the received LSA through the address mapping table. Then, at 561, the process 500 finds the least-recently used set of the cache line according to the LRU flag. Next, the process 500 overwrites the least-recently used set of the cache line with the incoming data and updates the respective tag at 562. At 563, the process 500 updates the LRU flag, resets the NOH flag to zero and sets the data validity flag to invalid. Then at 565, the process 500 performs a ‘write-thru’ operation to the SLC at the 1^{st} SPZA. The details of step 565 are shown in FIG. 5H. After the ‘write-thru’ operation is completed, the data validity flag is set back to valid at 566. Finally, the process 500 sends a data written acknowledgement message or signal back to the host 109 at 567 before going back to the ‘IDLE’ state.

Shown in FIG. 5H, the detailed process of step 565 starts at decision 565a. It is determined whether the just written set of the cache line is allowed to be directly written to the physical zone of the SLC at the 1^{st} SPZA. If ‘yes’, the incoming data in the just written set of the cache line is written directly into the respective location (i.e., sector) of the physical zone in the SLC at the 1^{st} SPZA at 565b before the process 500 returns.

If ‘no’, the process 500 allocates a new zone (2^{nd} SPZA) in the SLC at 565c. Next, the process 500 copies the data from the 1^{st} SPZA to the 2^{nd} SPZA with the update from the just written set of the cache line at 565d. Then, at 565e, the address mapping table is updated with the 2^{nd} SPZA. Next at decision 565f, it is determined whether the SLC has been used up to a predefined capacity (e.g., a fixed percentage to ensure at least one available data zone for data programming operation). If ‘no’, the process 500 returns. Otherwise at 535, the process 500 moves the lowest hit zone from the SLC to a new zone in the MLC. The details of step 535 are shown and described in FIG. 5D. The process 500 returns after the lowest hit zone in the SLC is erased for reuse.

According to one embodiment of the present invention, the SLC and the MLC are configured with same size data page such that the data movement between the SLC and MLC can be conducted seamlessly in the exemplary process 500.

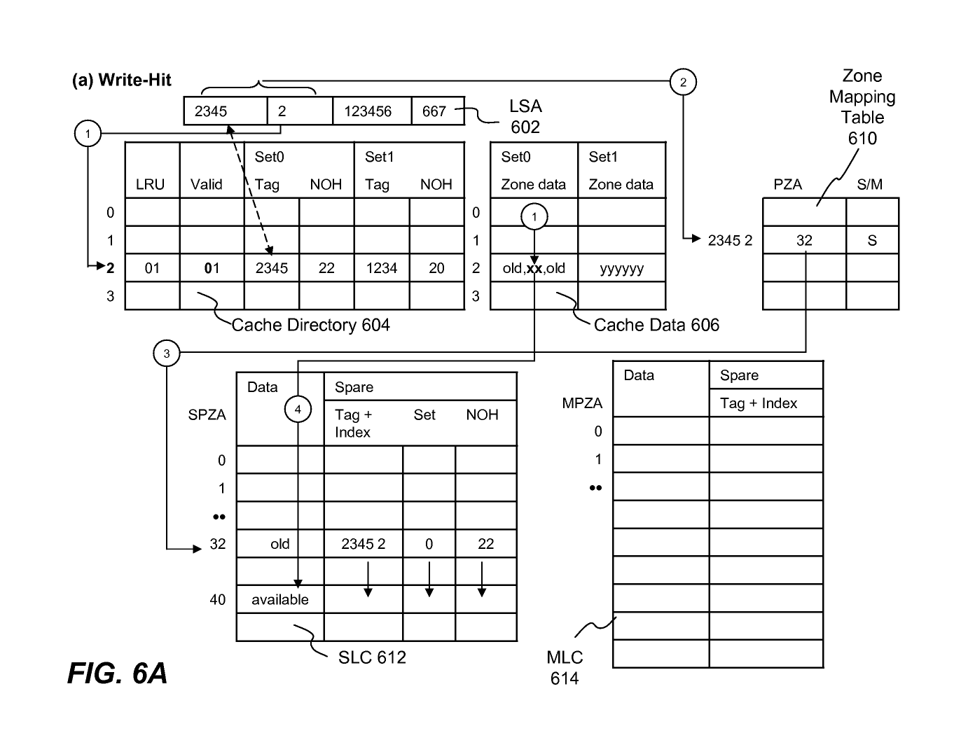

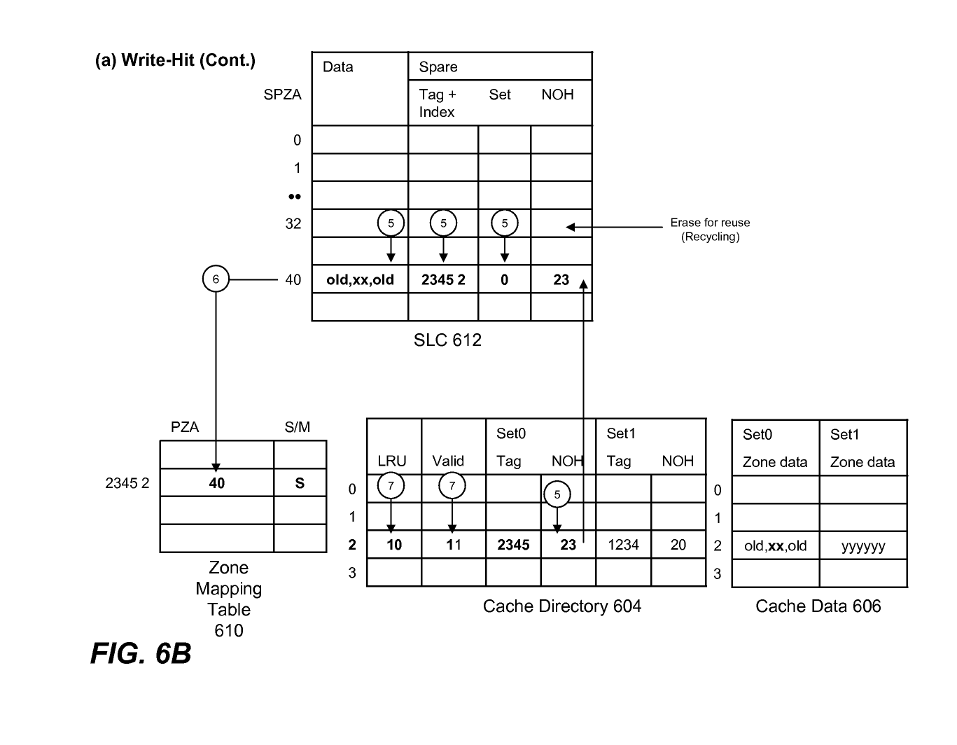

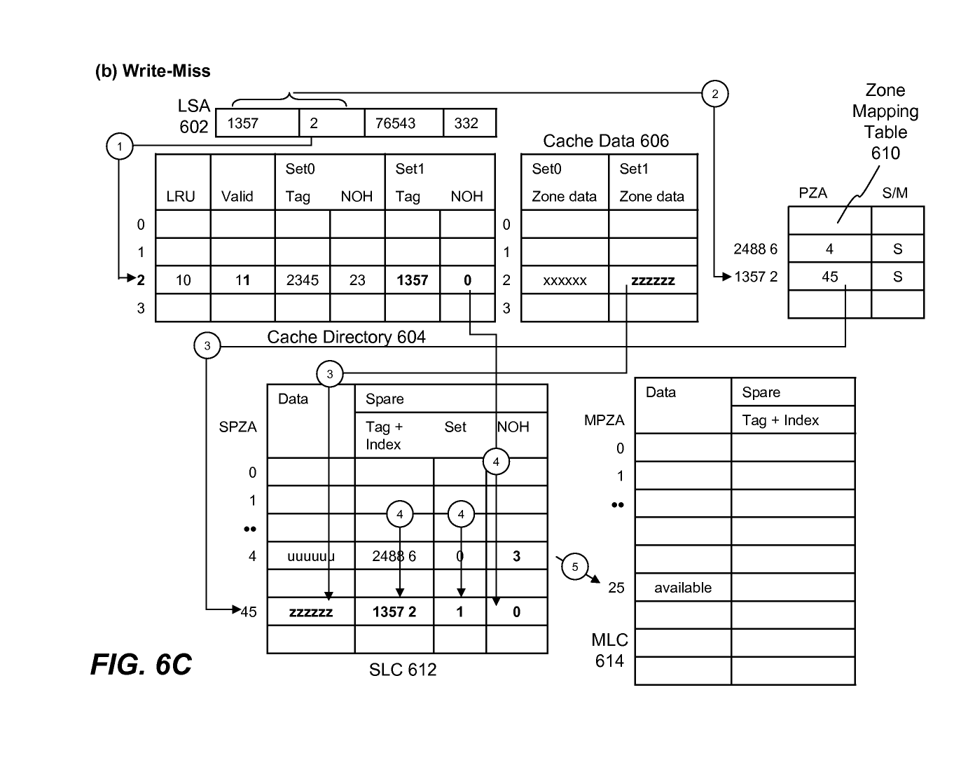

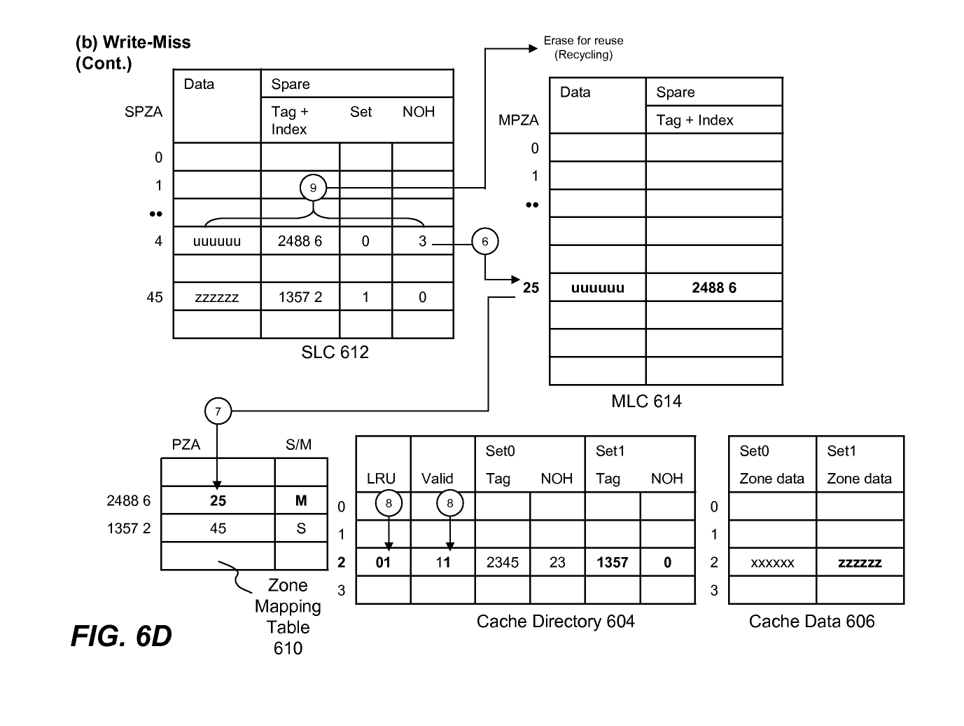

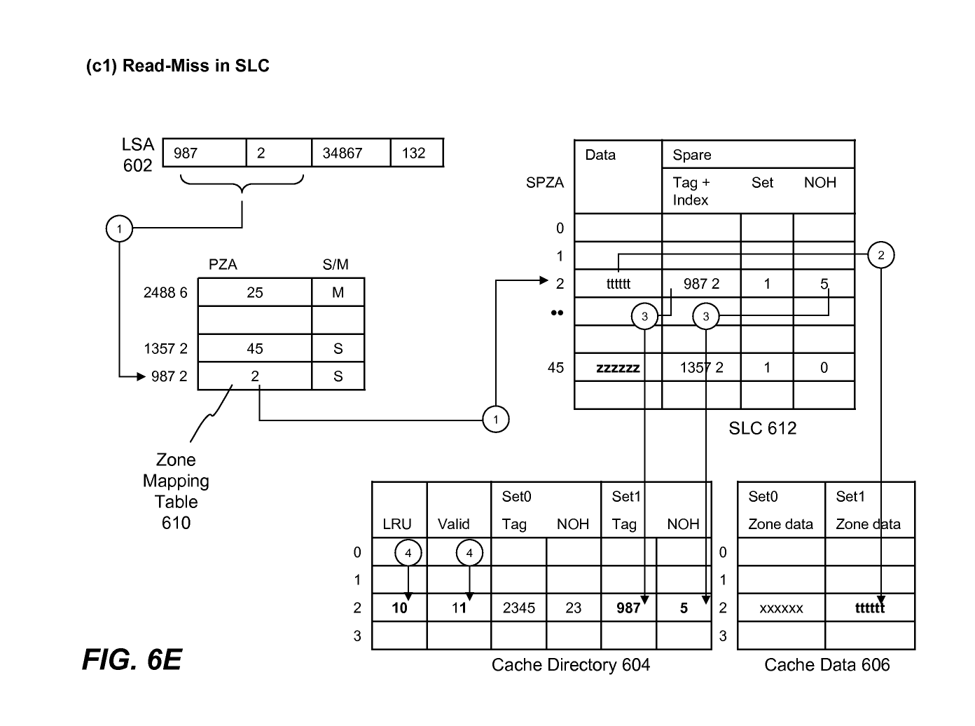

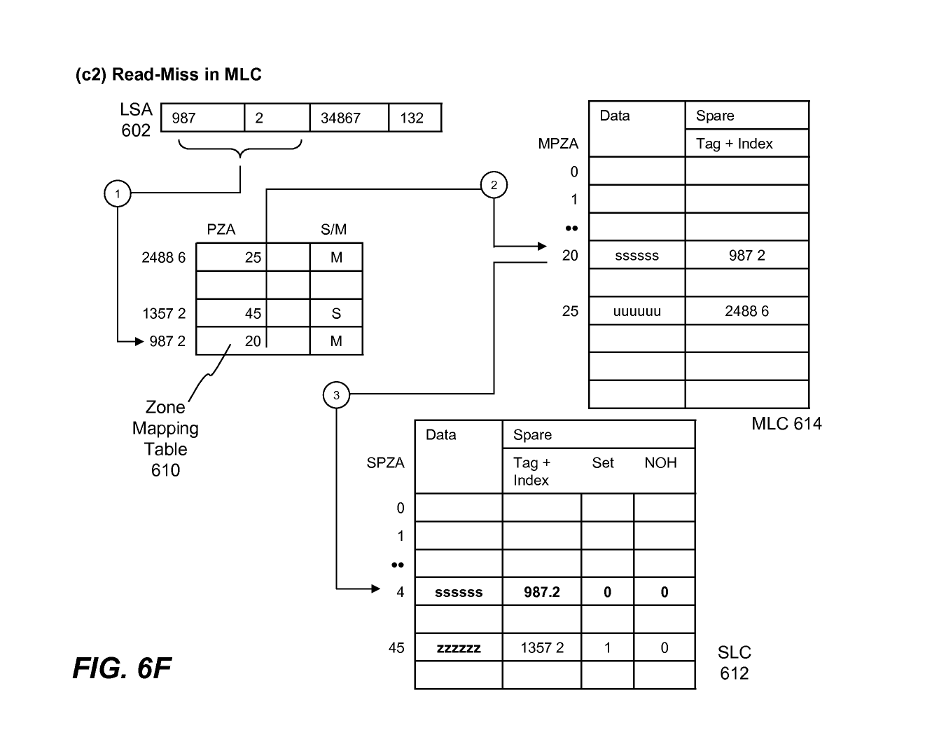

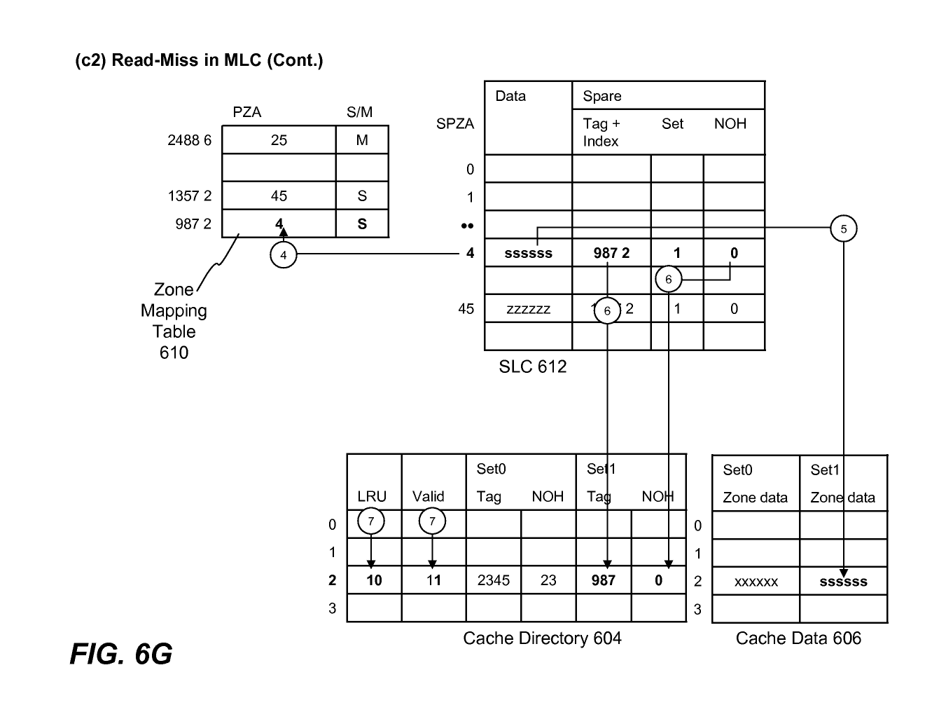

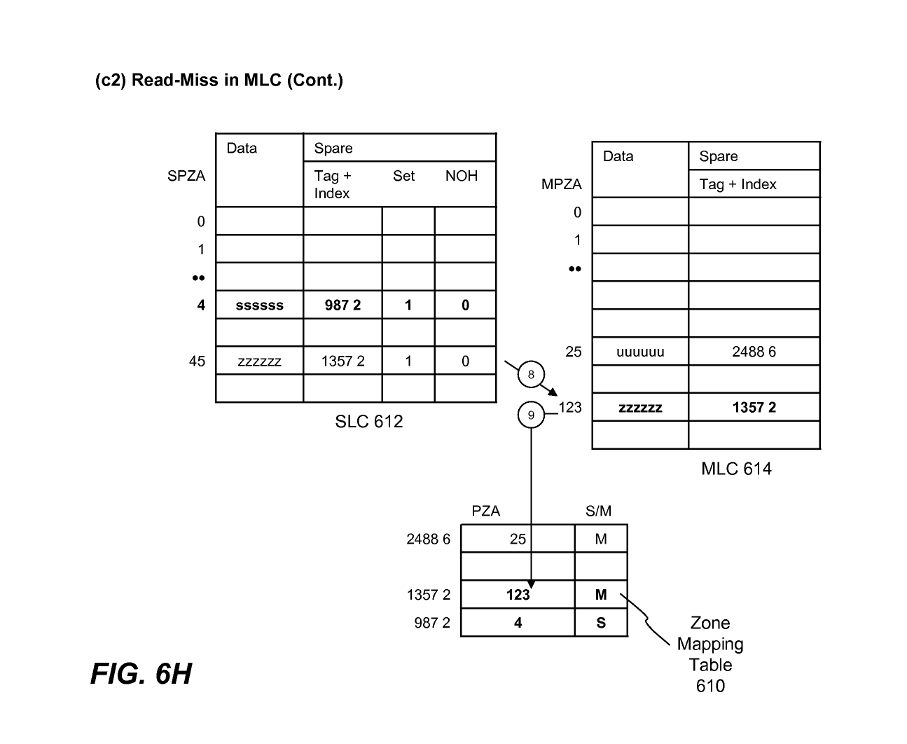

FIGS. 6A-6H shows a sequence of data transfer operations based on the exemplary process 500 in the NVMD 170 of FIG. 1B, according to an embodiment of the present invention. In order to simplify the illustration, the NVMD comprises a 2-set associative cache subsystem with non-volatile memory modules including a SLC and a MLC flash memory module.

The first data transfer operation is a ‘data write’ with a ‘cache-hit’ condition shown as example (a) in FIG. 6A and FIG. 6B. The data transfer operation is summarized as follows:
1) A logical sector address (LSA) 602 is received from a host (e.g., the host computer system 100 of FIG. 1B) with incoming data ‘xxxxxx’. Tag and index are extracted from the received LSA 602. The index is ‘2’ which means entry ‘2’ of the cache directory 604. It is used for determining whether there is ‘cache-hit’. The tag is ‘2345’, which matches the stored tag in ‘Set0’. The incoming zone data ‘xxxxxx’ is then written to ‘Set0’ of the cache line in cache data 606.
2) A corresponding physical zone address (SPZA ‘32’) is obtained through the address mapping table 610 at the received logical zone address, which is formed by combining the tag and the index extracted from the received LSA. Since the ‘cache-hit’ condition is determined, the SPZA ‘32’ is in the SLC 612 as indicated by an ‘S’ in the LTOP table 610.
3) SPZA ‘32’ is then checked if the incoming data ‘xxxxxx’ is allowed to be written directly into. In this example (a), the answer is no.
4) Accordingly, a new zone (SPZA ‘40’) in the SLC 612 is allocated.
5) Data in the old zone (i.e., SPZA ‘32’) is copied to the new zone (SPZA ‘40’) with the update (i.e., ‘xxxxxx’) from the ‘Set0’ of the cache line. Additionally, tag, index and set number stored in the spare area of the first page of SPZA ‘32’ is copied to the corresponding spare area of the first data page of SPZA ‘40’. The NOH flag is incremented in the cache directory 604 and then written into the spare area of the first page of SPZA‘40’.
6) The address mapping table 610 is updated with the new zone number SPZA‘40’ to replace the old zone number SPZA‘32’. The old zone at SPZA ‘32’ in the SLC 612 is erased for reuse.
7) Finally, the least-recently used (LRU) flag and the data validity flag are updated accordingly in the cache directory 604.
   It is noted that MLC 614 is not programmed at all in this example (a), thereby, prolonging the MLC endurance.

The second data transfer operation is a ‘data write’ with a ‘cache-miss’ condition shown as example (b) in FIG. 6C and FIG. 6D. The data transfer operation is summarized as follows:
1) A logical sector address (LSA) 602 is received from a host with incoming data ‘zzzzzz’, which may be a data zone. Tag and index are extracted from the received LSA 602. Again, the index is ‘2’ which means entry ‘2’ of the cache directory 604. The tag is ‘1357, which does not match any of the stored tags in cache entry ‘2’. Therefore, this is a condition of ‘cache-miss’. A least-recently used set is then determined according to the LRU flag in the cache directory 604. In this example (b), ‘Set1’ is determined to be the least-recently used. The incoming data ‘zzzzzz’ is then written into ‘Set1’ of the cache line in entry ‘2’. The NOH flag is reset to zero accordingly.
2) A corresponding physical zone address (SPZA ‘45’) is obtained through the address mapping table 610 at the received logical block address (LBA), which is formed by combining the tag and the index.
3) The just written data ‘zzzzzz’ in the ‘Set1’ of the cache line is then written into SPZA ‘45’ in the SLC 612.
4) The tag and the index, the set number (i.e., ‘Set1’) and the NOH flag are also written to the spare area of the first page of the physical zone SPZA ‘45’.
5) Next, if the SLC 612 has been used up to its predefined capacity, which is the case in the example (b), the lowest hit zone (SPZA ‘4’) is identified in the SLC 612 according to the NOH flag. A new available zone (MPZA ‘25’) in the MLC is allocated.
6) The data from the SPZA ‘4’ is copied to MPZA ‘25’ including tag and index in the first page.
7) The corresponding entry in the address mapping table 610 is updated from SPZA ‘4’ to MPZA ‘25’. The lowest hit zone in the SLC at SPZA ‘4’ is erased for reuse.
8) Finally, the LRU flag and the data validity flag are updated accordingly.
   It is noted that the MLC 614 is written or programmed only when the predefined capacity of the SLC 612 has been used up.

The third data transfer operation is a ‘data read’ with a ‘cache-miss’ in the SLC shown as example (c1) in FIG. 6E. The data transfer operation is summarized as follows:
1) A logical sector address (LSA) 602 is received from a host. Tag and index are extracted from the received LSA 602. The tag and index is ‘987 2’ which represents the logical block address (LBA). A physical zone address is obtained through the address mapping table 610. In the example (c1), the SPZA ‘2’ in the SLC 612 is determined.
2) The data ‘tttttt’ stored at SPZA ‘2’ is copied to the least-recently used set of the cache line, which ‘Set1’ in the example (c1).
3) Corresponding tag and the NOH flag are copied from the spare area of the first page of the SPZA ‘2’ to the cache directory.
4) The LRU and data validity flags are also updated accordingly.
   Again, it is noted that the MLC is not programmed or written at all in the example (c1).

The fourth data transfer operation is a ‘data read’ with a ‘cache-miss’ in the MLC shown as example (c2) in FIGS. 6F-6H. The data transfer operation is summarized as follows:
1) A logical sector address (LSA) 602 is received from a host. Tag and index are extracted from the received LSA 602. The tag and the index is ‘987 2’ which represents the logical block address (LBA). A physical zone address is obtained through the address mapping table 610.
2) In this example (c2), the MPZA ‘20’ in the MLC 614 is determined.
3) A new zone SPZA ‘4’ is allocated in the SLC 612, and the data ‘ssssss’ stored at MPZA ‘20’ is copied into the SLC at SPZA ‘4’ and the tag and index ‘987 2’ in the first page is copied also.
4) The address mapping table 610 is updated with SPZA ‘4’ replacing MPZA ‘20’ in the corresponding entry.
5) The data ‘ssssss’ stored at SPZA ‘4’ is then copied to the least-recently used set of the cache line, which is ‘Set1’ in the example (c2).
6) Corresponding tag and the NOH flag are copied from the spare area of the first page of the SPZA ‘4’ to the respective locations in the cache directory.
7) The LRU and data validity flags are also updated accordingly.
8) Finally, if the SLC has reached the predefined capacity, a new zone MPZA ‘123’ in the MLC 614 is allocated. The data stored in the lowest hit zone SPZA ‘45’ in the SLC 612 is copied to the MPZA ‘123’ including tag and index in the first page.
9) Finally, the address mapping table 610 is updated with MPZA ‘123’ replacing SPZA ‘45’.
   It is noted that the MLC is not programmed or written unless the SLC has reached its predefined capacity.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a 2-way set associative data cache subsystem has been shown and described, other data cache subsystem such as 4-way set associative, direct mapping, any other equivalent system may be used instead. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A zone-based non-volatile memory device (NVMD) comprising:
at least one non-volatile memory (NVM) module configured as a data storage of a host computer system as the NVMD is adapted to the host, wherein the at least one NVM module is partitioned into a plurality of data blocks, each of the data blocks is further divided into a plurality of zones, each of the zones comprises a plurality of data pages and each of the data pages includes at least one data sector;
a NVM controller configured to manage one or more data read, data write and data erasure operations of the at least one NVM module, wherein the data write operation comprises writing data into any empty zone of the plurality of zones, while data erasure operation comprises erasing data of entire zone in a zone by zone basis; and
an input/output (I/O) interface, coupling to the NVM controller, configured for receiving incoming data from the host and configured for sending outgoing data to the host.

2. The device of claim 1 further comprises a data cache subsystem, coupling to the NVM controller, configured to store most recently accessed data.

3. The device of claim 2, wherein said at least one NVM module comprises first and second types of NVM.

4. The device of claim 3, wherein the first type and the second type are so configured that data programming to the second type is minimized.

5. The device of claim 3, wherein the first type of NVM and the second type of NVM comprises same size of zone.

6. The device of claim 3, wherein capacity of the first type of NVM is substantially smaller than that of the second type of NVM and substantially larger than that of the data cache subsystem.

7. The device of claim 3, wherein the first type of NVM comprises Single-Level Cell flash memory and the second type of NVM comprises Multi-Level Cell flash memory.

8. The device of claim 2, wherein the data cache subsystem is configured to use size of each of the plurality of zones as a basic unit.

9. The device of claim 1, wherein each of the data sector comprises 512 bytes.

10. The device of claim 1, wherein the NVM controller is configured to perform a two-level address mapping scheme converting a logical address received from the host to a virtual zone address then to a physical zone address of the at least one NVM module.

11. The device of claim 10, wherein the logical address is a data sector address in a linear space.

12. The device of claim 10, wherein the virtual zone address is determined by a scheme in which number of sectors per zone is predefined.

13. The device of claim 10, wherein the physical zone address corresponds to one of the plurality of zones of the at least one NVM module.

14. The device of claim 1, wherein said I/O interface comprises Advanced Technology Attachment (ATA), Serial ATA (SATA), Small Computer System Interface (SCSI), Universal Serial Bus (USB), Peripheral Component Interconnect (PCI) Express, ExpressCard, fiber channel Interface, optical connection interface circuit, Secure Digital.

15. A non-volatile memory device (NVMD) comprising:
a central processing unit (CPU);
at least one non-volatile memory (NVM) module configured as a data storage of a host computer system, when the NVMD is adapted to the host, wherein the at least one NVM module is partitioned into a plurality of data blocks, each of the data blocks is further divided into a plurality of zones, each of the zones comprises a plurality of data pages and each of the data pages includes at least one data sector;
a NVM controller, coupling to the CPU, configured to manage data transfer operations of the at least one NVM module;
a data cache subsystem, coupling to the CPU and the NVM controller, configured for caching data between the NVM module and the host; and
an input/output (I/O) interface, coupling to the NVM controller, configured for receiving incoming data from the host to the data cache subsystem and configured for sending outgoing data from the data cache subsystem to the host.

16. The device of claim 15, wherein said data cache subsystem comprises dynamic random access memory.

17. The device of claim 15, wherein said at least one non-volatile memory comprises single-level cell flash memory.

18. The device of claim 15, wherein said at least one non-volatile memory comprises multi-level cell flash memory.

19. The device of claim 15, wherein each of the plurality of zones is configured to be erased in one data erasure operation.

20. The device of claim 15, wherein each of the plurality of zones is configured to allowed to be programmed only when said each of the zones is empty.
